(19) United States
(12) Patent Application Publication
(10) Pub. No.: US 2004/0212985 A1
(43) Pub. Date: Oct. 28, 2004

(54) Electro luminescent and or magnifying bookmark

(76) Inventor: Robert J. Travis, Graniteville, SC (US)

Correspondence Address: Robert J Travis, 300 Fairway Dr., Graniteville, SC, 29829, US

(21) Appl. No.: 10/425,552

(22) Filed: Apr. 28, 2003

(51) Int. Cl. F21V 9/16

(52) U.S. Cl. 362/84

(57) ABSTRACT

The present invention is an electro luminescent and or magnifying bookmark. The illumination of the bookmark is achieved through electro luminescent technology. All of the electronic components of the EL lamp make up the entire bulk of the bookmark. The EL lamp can be turned off or on depending on user's need to illuminate text. For the purpose of description, the magnification will always be thought of as external to the bookmark, such that it is a peripheral and optional application. The magnification is achieved by a lens comprising a flat rectangular or other suitable shape of transparent plastic sheet material having fresnel lens contours molded in its upper surface producing desired magnification. The magnification lens can be added or removed from the bookmark at the user's discretion. Whatever shape and dimension the El bookmark takes, the magnifying lens, to be cooperative must follow in shape and dimension. The magnifying lens is added or removed by cylindrical housing positioned on the edge of two parallel sides of the lens' decided shape and dimension, so that when paired, the EL bookmark and lens can function as one unit. This single unit is achieved by means of said long cylindrical grooves down the lens' side, such that from a frontal perspective one can see the accentuated “C” shape and on the other side a backwards “C” shape. The magnifying lens can then slide on and off of the two rails along the respective sides of the bookmark. The shape of the EL bookmark can be virtually any size sufficient to provide both a suitable sized bookmark, and enough surface area to illuminate text.

### CROSS-REFERENCE TO RELATED APPLICATIONS

NONE

### FEDERALLY SPONSORED RESEARCH

NONE

### SEQUENCE LISTING OR PROGRAM

NONE

### BACKGROUND OF INVENTION—FIELD OF INVENTION

This invention is related to bookmarks, specifically one that illuminates and can be coupled with a magnifying lens.

### BACKGROUND OF THE INVENTION

There have long been bookmarks, means of illuminating text, and magnifying glasses available to assist people in reading books, documents and the like.

As an example, a bookmark such as that showed in U.S. Pat. No. 3,140,883 issued to R. L. Anthony on Jul. 14, 1964 may be integrally attached to a book such as a telephone directory or a dictionary, wherein the end of the bookmark is provided with a sealed pocket for receiving a plastic magnifying lens. The magnifying lens may be moved up and down the page as desired to provide magnification of the text in the book. This permits the user to read the text without first putting on his eyeglasses.

Further, a pocket magnifier such as that showed in U.S. Pat. No. 3,409,347 issued to R. Vogel on Nov. 5, 1968 includes a pocket pouch to be carried in the breast or hip pocket of the user or in a purse or wallet. The lens is formed of a transparent plastic sheet material having a substantial degree of stiffness and having fresnel lens contours molded in its upper surface. The lens unit may be retracted into and extended out of the pocket. The pocket magnifier may be easily utilized to magnify small print and the like when the user is in a location where it is not feasible or desirable to stop an activity in order to put on reading glasses.

And a lighted bookmark such as that shown in U.S. Pat. No. 358,984 issued to Rudy A. Vandenbelt on Jun. 6, 1995. It constitutes a thin, flat plastic retainer that serves as a bookmark such that a light bearing neck retracts in and out of the center of the bookmark by means of a recessed track. The light bearing neck can either be housed in the bookmark or fully extended to reveal a light positioned a sufficient distance above the page to offer optimum lighting.

And finally a bookmark with a flashlight such as that shown in U.S. Pat. No. D436, 374 Issued to Randolph J. Mershon on Jan. 16, 2001 that constitutes a flashlight attached to a bookmark by means of adhesive or plastic molding. The flashlight is attached to an extension of the bookmark located such that the light shines from above the text, or from the top of the page to the bottom.

### BACKGROUND OF INVENTION—OBJECTS AND ADVANTAGES

Others have invented bookmarks that magnify and or illuminate text but mine is superior because:

My bookmark will illuminate text for those whom read in little or no ambient light. Further I have paired a magnifying lens with the bookmark for those whom desire magnification. Together they function as one unit.

The electro luminescent lamp is the bookmark, where other bookmarks have an external light attached to the bookmark.

My bookmark can be made to magnify using an ultra-thin lens roughly the same size as the bookmark. The lens is formed of a transparent plastic sheet material having a substantial degree of stiffness and having fresnel lens contours molded in its upper surface.

### SUMMARY

I provide a bookmark that both illuminates and or magnifies text. With my invention the bookmark is the light source. The magnifying lens can then slide on or off of the EL Lamp -the illuminating bookmark- producing in the end a bookmark that both illuminates and magnifies.

### DRAWINGS—FIGURES

FIG. 1, 2, part of 4, 5 and 6 are marked with hatching representing the EL bookmark.

FIG. 5, 6, and part of 4 are marked with concentric rings representing the magnifying lens.

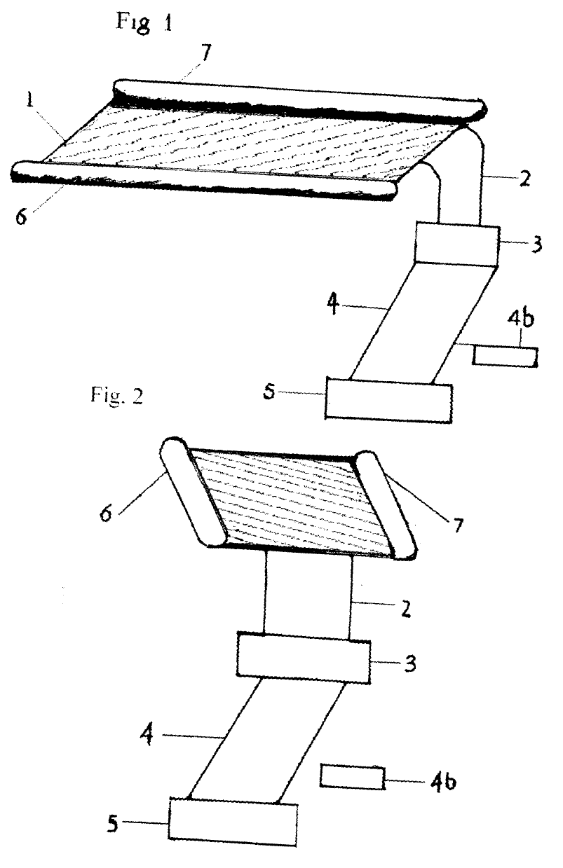

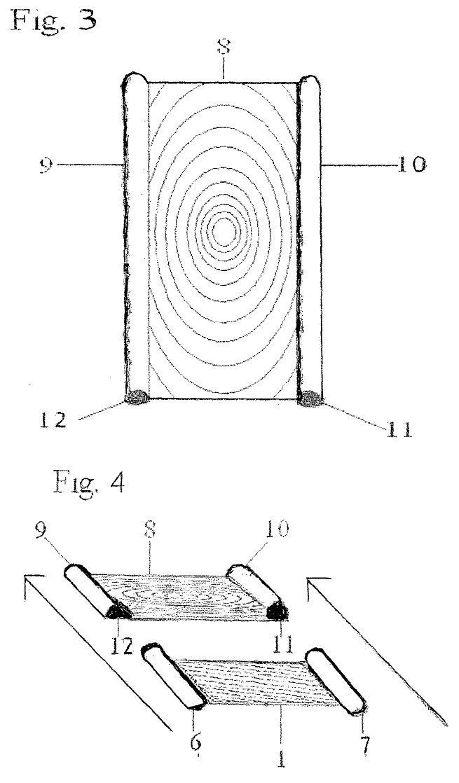

FIG. 1 and 2 show components in an electro luminescent bookmark and the cylindrical alignment rails on two of its sides.

FIG. 3 is an overhead view of the magnifying lens with cylindrical housing.

FIG. 4 is a view of both the EL lamp film and magnifying lens before connection is made.

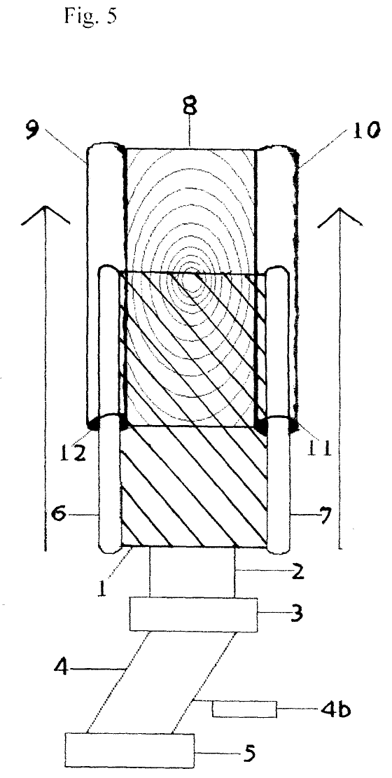

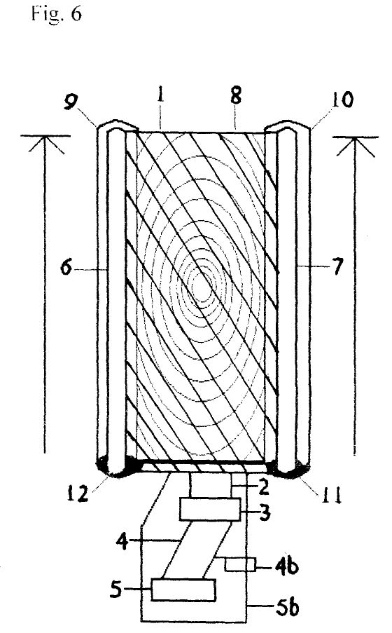

FIG. 5 Is an overhead view of both EL bookmark and magnifying lens halfway connected. The cylindrical housing 9 and 10 along the sides of the magnifying lens are shown larger than the actual width as to depict the difference between the alignment rails 6 and 7 and the grooves that slide onto those rails.

FIG. 6 depicts EL bookmark and magnifying lens fully connected. There too, the widths of the housings are accentuated, to depict the difference between rail and grooves.

### DRAWINGS—REFERENCE NUMERAL

1 surface of EL lamp

2 electric connection to EL lamp

3 Inverter

4 electric connection to inverter

4b switch

5 direct current battery power source

5b electric hardware casing

6 Alignment rail

7 Alignment rail

8 surface of magnifying lens

9 groove

10 groove

11 opening to groove

12 opening to groove

### DESCRIPTION—PREFERRED EMBODIMENT

preferred embodiment of the invention is as follows. FIG. 1 shows bookmark surface 1 which is made to illuminate text by means of electro luminescent lamp film. This EL lamp film is produced by World EL of Watsonville, Calif. and can be made to fit any size. Along two of the bookmark sides are alignment rails 6 and 7. The rails can be made of a flexible plastic, such as poly-ethylene-tere-phthalate (PET-hyphens here supplied to facilitate pronunciation)- available from Eastman Chemical Co. of Kingsport, Tenn. However, the rails can consist of any other material that can be repeatedly bent without fracturing, such as polyethylene, polypropylene, vinyl, nylon, rubber, various impregnated or laminated fibrous materials, various plasticized materials cardboard, etc.

power is supplied to the EL bookmark by a Direct Current battery 5 turned on or off by switch 4b and connected to the inverter 3 by means of conductive wire 4. All of this is housed in a substantially small case 5b external to the EL bookmark. This case can be manufactured in the same manners as the above alignment rails 6 and 7.

FIG. 3 shows a thin fresnal-type contour lens 8 used for magnification with the same surface dimension as the bookmark 1. The cylindrical housing 9 and 10 are positioned on two sides of magnifying lens 8. These cylindrical housings follow the above list of products as a means of potential manufacturing. There are two openings 11 and 12 at one of the two ends of the cylindrical housing 9 and 10.

FIG. 4 shows the magnifying lens 8 can slide on or off of the EL bookmark 1.

FIG. 5 shows the entire bookmark 1 halfway connected to magnifying lens 8

FIG. 6 shows the entire bookmark 1 fully connected to magnifying lens 8

### Operation

The surface of the EL bookmark 1 can be made to illuminate with power coming from a direct current battery source 5. That source can be turned on or off by switch 4b depending on whether the user wants to illuminate text. If turned on, the batteries' direct current is changed to alternating current by invertor 3, which then is connected to bookmark 1 by connector 2. The driving AC voltage is within the range of 50-180 volts cycling between 50-2000 Hz, depending on level of brightness. All of the electronics that are used to illuminate bookmark 1 are housed in case 5b as seen in FIG. 6. The bookmark 1 can then be paired with magnifying lens 8 by means of cylindrical housing 9 and 10 that slide on and off of alignment rails 6 and 7 of bookmark 1. With both bookmark 1 and lens 8 paired together as in FIG. 6, the reader can illuminate and magnify text.

### Conclusion, Ramifications, and Scope

In conclusion, there is no other product in this field quite as effective, efficient, and compact as this electro luminescent and magnifying bookmark. There is a great potential for use not only with those who must illuminate text but who also have visual impairments. It can be used to provide needed light or magnification for countless reasons, such as map reading, rustling through a dark glove-compartment, or a dark purse. The scope, as defined by need, is massive. There is great potential, not only in the U.S. but also around the world.

### ALTERNATIVE EMBODIMENTS

### Different materials can be used to pair magnifying lens with EL bookmark such that the rails can be made not only of rubbers, and plastics, but also magnets.

Different sizes can be made of EL bookmark and magnifying lens.

Furthermore a clip can be made to screw, snap, slide, etc. to the EL bookmark, preferably attached to the battery, switch, and invertor housing at the end of the EL bookmark. This would allow the user to clip the bookmark onto maps and guides, etc.

1. A 2-layer illuminating lamp film of sufficient size as to be used while reading, comprising:
a. said body of lamp film as in claim 1 wherein said film is made of transparent electro luminescent, preferably rectangular film.
b. said body of EL lamp film of claim 1 wherein long cylindrical parallel alignment rails are adhered along the edge of EL lamp film.
(i) said parallel rails of claim b wherein adherence provides a method to permanently press and hold the said 2-ply EL lamp film together as is necessary for illumination.
c. said body of lamp film as in claim 1 wherein said film illuminates when a sufficient quantity of alternating current is applied.
(i) said alternating current as in claim c wherein direct current from a battery source is changed to alternating current by an inverter.

2. a case containing the necessary hardware to illuminate said EL lamp film
a. said case as in claim 2 including DC battery, invertor, wires, and switch.
b. said case as in claim 2 wherein size of case is substantially small as to be used as part of the bookmark.

3. an optional magnifying lens formed of a transparent plastic sheet of material having a substantial degree of stiffness and having fresnel lens contours molded in its upper surface.
a. the said magnifying lens of claim 3 wherein two cylindrical grooves are adhered to the magnifying lens such that it can slide off and on the alignment rails of said EL bookmark.
b. said magnifying lens of claim 3 wherein said lens conforms to the shape of the bookmark.

4. the cooperation of said grooves and rails allows said magnifying lens to be retracted in and out of said bookmarker to either be used individually or in tandem, whereby the reader can both illuminate and magnify text.
